(19) United States
(12) Patent Application Publication
(10) Pub. No.: US 2013/0141425 A1
(43) Pub. Date: Jun. 6, 2013

(54) THREE-DIMENSION IMAGE PROCESSING METHOD

(71) Applicants: Chun-Wei CHEN, Taipei City (CN); Guang-Zhi LIU, Shanghai (CN)

(72) Inventors: Chun-Wei CHEN, Taipei City (CN); Guang-Zhi LIU, Shanghai (CN)

(73) Assignee: NOVATEK MICROELECTRONICS CORP., Hsinchu (TW)

(21) Appl. No.: 13/532,888

(22) Filed: Jun. 26, 2012

(30) Foreign Application Priority Data
Dec. 6, 2011 (CN) 201110402308.5

(51) Int. Cl. G06T 15/00

(52) U.S. Cl. 345/419

(57) ABSTRACT

A three-dimension (3D) image processing method is disclosed. First and second eye frames of a 3D image is generated from a frame of an original two-dimension (2D) image. First and second mask areas are generated at first and second boundaries of the first eye frame respectively. Third and fourth mask areas are generated at first and second boundaries of the second eye frame respectively. A length of each the first and the fourth mask areas includes a length of a comparison area whose length is determined according to a pixel data difference obtained by comparing the first eye frame with the second eye frame. A length of each the first to the fourth mask areas further includes a length of a first extension border area.

This application claims the benefit of People's Republic of China application Serial No. 201110402308.5, filed on Dec. 6, 2011, the subject matter of which is incorporated herein by reference.

### BACKGROUND

1. Technical Field

The disclosure relates in general to a three-dimension (3D) image processing method.

2. Description of the Related Art

As three-dimension (3D) image provides more fun in terms of entertainment, more and more display apparatuses (such as 3D TV) support 3D image display. Since image signals received by the 3D display apparatus may be two-dimension (2D) image signals, the 3D display apparatus converts the 2D image signals into 3D image signals.

The process of converting a 2D image into a 3D image (also referred as 3D wrapping) is made with reference to a depth map. Here, “depth” refers to the degree of closeness of an object sensed by a viewer when watching an image. The depth map has many depth bits, each representing the depth of a pixel in the 2D image. Based on the 2D image with a known view angle and its corresponding depth map, a stereoscopic image may thus be provided to the viewer.

A 3D image includes a left-eye image signal and a right-eye image signal. When viewing the 3D image, if disparity occurs between the left-eye image signal viewed by the left-eye and the right-eye image signal viewed by the right-eye, the viewer would feel that the object is stereoscopic. Conversely, if there is no disparity, the viewer would feel that the object is planar.

In general, to display the object at a far distance, the left-eye image signal is shifted to the left and the right-eye image signal is shifted to the right. Conversely, to display the object at a near distance, the left-eye image signal is shifted to the right and the right-eye image signal is shifted to the left. The shift directions and shift magnitudes of the left-eye image signal and the right-eye image signal may be obtained by looking up the depth map.

However, in converting into 3D images, borders may be generated at boundaries of the left-eye image signal and the right-eye image signal. Borders may negatively affect a visual area of the 3D image and viewer's comfort.

### SUMMARY OF THE DISCLOSURE

The embodiments disclosed in the disclosure are related to a 3D image processing method in which asymmetric virtual borders can be generated.

The embodiments disclosed in the disclosure are related to a 3D image processing method, in which the generated virtual borders and the 3D image do not have to be displayed on the same visual planes.

According to an exemplary embodiment of the present disclosure, a three-dimension (3D) image processing method is disclosed. The method includes: generating first and second eye frames of a 3D image from a frame of an original two-dimension (2D) image; generating first and second mask areas at first and second boundaries of the first eye frame respectively; and generating third and fourth mask areas at first and second boundaries of the second eye frame respectively. A length of each of the first and the fourth mask areas includes a length of a comparison area whose length is determined according to a pixel data difference obtained by comparing the first eye frame with the second eye frame. Length of each of the first to the fourth mask areas further includes a length of a first extension border area.

According to an exemplary embodiment of the present disclosure, a 3D image processing method is disclosed. The method includes: generating first and second eye frames of a 3D image from a frame of an original two-dimension image; generating first and second mask areas at first and second boundaries of the first eye frame respectively; and generating third and fourth mask areas at first and second boundaries of the second eye frame respectively. Lengths of the first to the fourth mask areas respectively are first to the fourth lengths, none of the first to the fourth lengths is equal to 0, the first length is not equal to the third length, and the second length is not equal to the fourth length.

The above and other contents of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a flowchart of a 3D image processing method according to an embodiment of the disclosure;

FIG. 2A shows image processing for a left border LB of a left eye frame and a left border LB of a right eye frame of a remote 3D image according to the embodiment of the disclosure;

FIG. 2B shows image processing for a right border RB of a left eye frame and a right border RB of a right eye frame of a remote 3D image according to the embodiment of the disclosure;

FIG. 3A shows image processing for the left border LB of the left eye frame and the left border LB of the right eye frame of a nearby 3D image according to the embodiment of the disclosure; and

FIG. 3B shows image processing for the right border RB of the left eye frame and the right border RB of the right eye frame of a nearby 3D image according to the embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

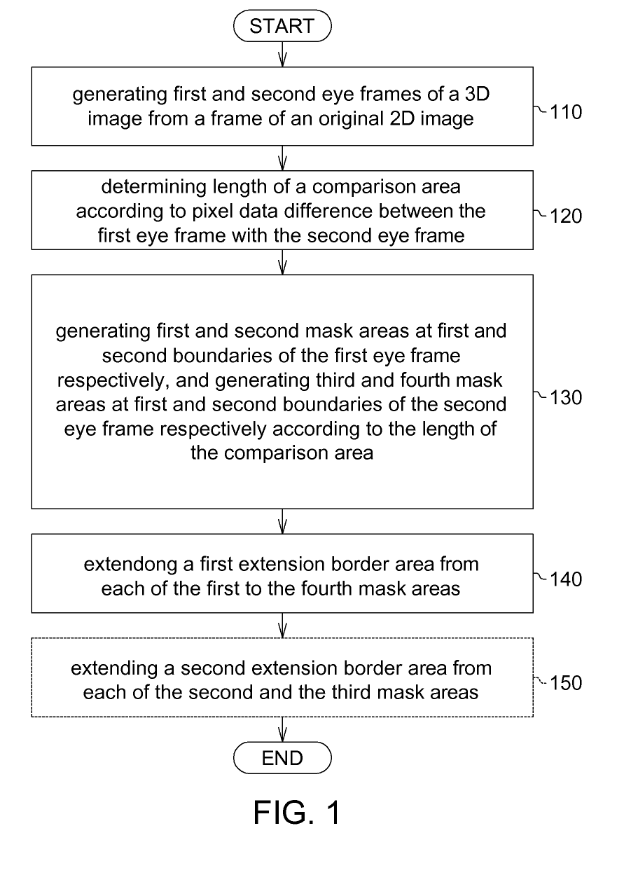

Referring to FIG. 1, a flowchart of a 3D image processing method according to an embodiment of the disclosure is shown. In step 110, a first eye frame and a second eye frame of a 3D image are generated from a frame of an original 2D image. Exemplarily but not restrictively, the first eye frame is any one of a left eye frame and a right eye frame, and the second eye frame is the other one of the left eye frame and the right eye frame. For example, in step 110, the frame of the original 2D image is shifted by a shift distance along two opposite directions for respectively generating the first and the second eye frames.

In step 120, a length of a comparison area is determined according to pixel data difference between the first eye frame and the second eye frame.

In step 130, first and second mask areas at first and second boundaries of the first eye frame are respectively generated and third and fourth mask areas at first and second boundaries of the second eye frame are respectively generated according to the length of the comparison area.

In step 140, a first extension border area is further extended from each of the first to the fourth mask areas.

Selectively, in step 150, a second extension border area is further extended from each of the second and the third mask areas. It is noted that as indicated in FIG. 1, step 150 is demarcated with dotted lines to indicate that the step is an optional step and whether step 150 is performed is based on design needs. In addition, in another embodiment, step 140 may also be an optional step, but step 150 is performed. Moreover, the sequence of steps 110-150 in FIG. 1 is shown for purpose of illustrating the length relationships between different areas, and the sequence may be modified without being limited to the sequence as shown in FIG. 1.

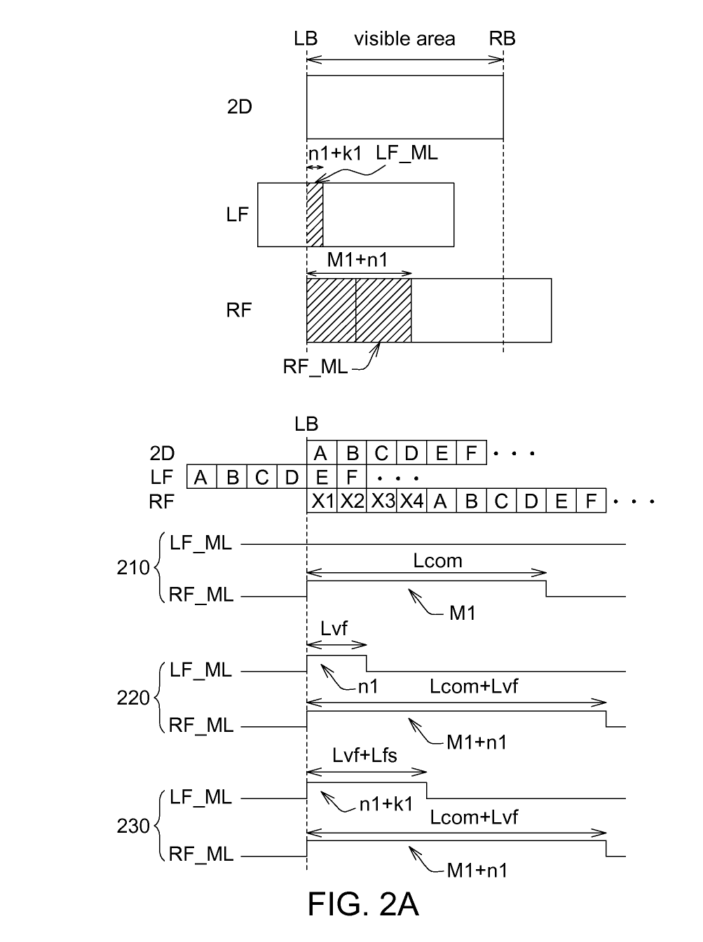

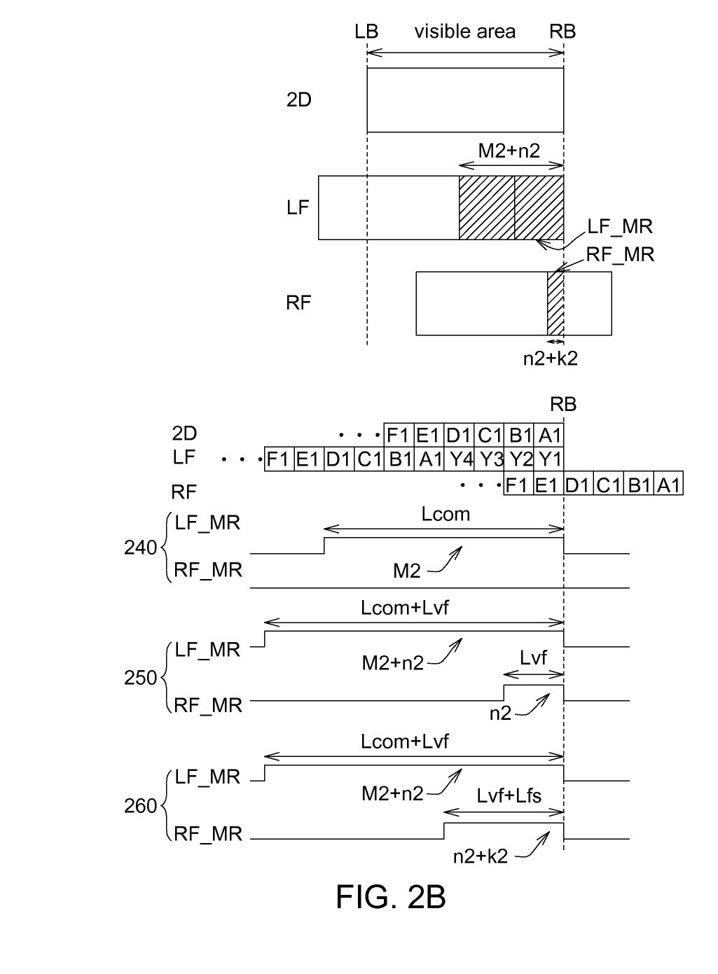

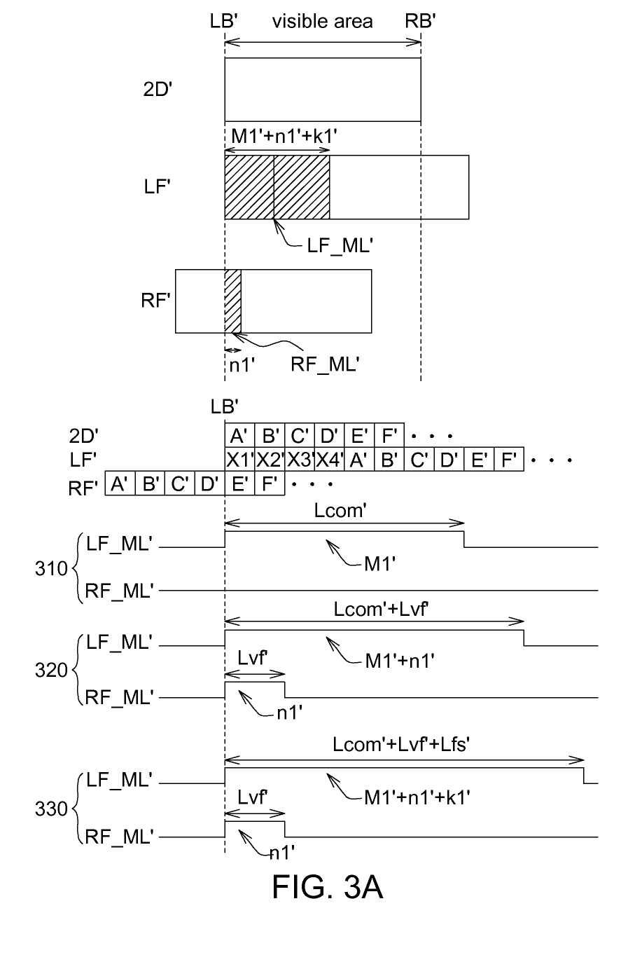

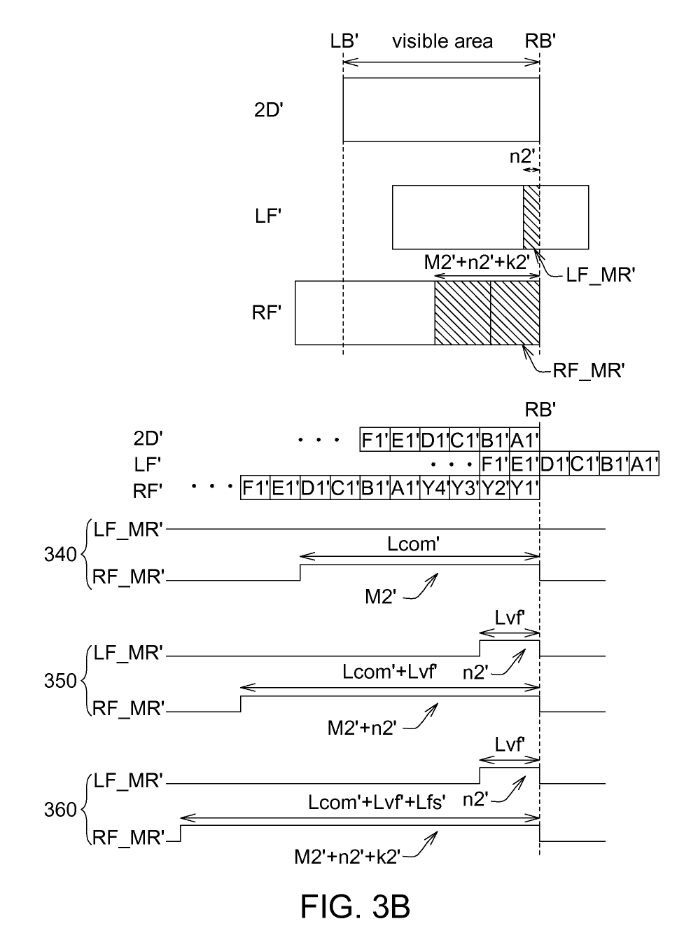

Details of steps 120-150 of the 3D image processing method indicated in FIG. 1 are elaborated with the embodiments indicated in FIG. 2A-FIG. 3B. As indicated in FIG. 2A-FIG. 3B, similar numeric designations denote similar meanings. In addition, the embodiments indicated in FIG. 2A-FIG. 3B also elaborate the length relationship between the first to the fourth mask areas and the comparison area, and the length relationship between the first extension border area and the second extension border area of steps 120-150.

### Remote Image Processing:

FIG. 2A shows image processing for a left border LB of the left eye frame and a left border LB of the right eye frame of a remote 3D image according to the embodiment of the disclosure. FIG. 2B shows image processing for a right border RB of the left eye frame and a right border RB of the right eye frame of a remote 3D image according to the embodiment of the disclosure. When watching a remote 3D image, the viewer would feel that the 3D image is displayed at a remote distance. That is, the viewer would feel that the 3D image is displayed at the rear of the screen.

Please refer to both FIG. 1 and FIG. 2A. The designation 2D denotes an original 2D image. The designations LF and RF denote the left and the right eye frames respectively. The designations LB and RB denote the left border LB and the right border RB respectively. The visible area denotes the area visible to the viewer when watching a 2D image or a 3D image.

Firstly, step 110 of FIG. 1 is elaborated. In FIG. 2A, pixels of one pixel row at the left border LB of the frame of the 2D image 2D are sequentially A, B, C, D, E, F . . . , from left to right. In step 110, the frame of the 2D image 2D is shifted to the left by a shift distance to generate the left eye frame LF, and the frame of the 2D image 2D is shifted to the right by the shift distance to generate the right eye frame RF. It is noted that, the actual resolution of the 2D image is not limited to the exemplification of the present embodiment. In addition, the shift distance is exemplified by 4 pixels, but the disclosure is not limited thereto. For example, the shift distance may also be ½, ¼, or ⅛ or any other number of pixels.

Next, step 120 of FIG. 1 is elaborated. As indicated in FIG. 2A, since the right eye frame RF is shifted to the right by 4 pixels, the four pixels at the left border LB of the right eye frame RF are removed and do not carry any meaning (denoted by X1-X4). On one hand, since the left eye frame LF is shifted to the left by 4 pixels, the originally 4 left-most pixels A-D of the left eye frame LF are removed outside the visible area and become invisible.

The comparison between the left eye frame LF with the right eye frame RF shows that at the left border LB, the pixels X1-X4 and A-D appear in the right eye frame RF but not in the left eye frame LF. Thus, the area in which the pixels X1-X4 and A-D are located is defined as a comparison area M1 whose length is twice as the shift distance.

Next, step 130 of FIG. 1, which corresponds to step 210 of FIG. 2A, is elaborated. In step 210, a mask area LF_ML is generated at the left border LB of the left eye frame LF, and a mask area RF_ML is generated at the left border LB of the right eye frame RF according to the length of the comparison area M1. The length of the mask area LF_ML at the left border LB of the left eye frame is temporarily equal to 0. The mask area RF_ML of step 210 includes the comparison area M1, or, the length of the mask area RF_ML includes the length Lcom of the comparison area M1. Thus, after step 210, no pixel is masked at the left border LB of the left eye frame LF, and Lcom pixels are masked at the left border LB of the right eye frame RF.

In other words, in steps 120 and 130, the left eye frame LF is compared with the right eye frame RF, the area, in which pixel data not in the left eye frame LF but in the right eye frame RF are located, is defined as the comparison area M1 and is masked. The principles of step 120 and 130 are that: the viewer cannot focus a pixel unless the pixel is seen by both the left eye and the right eye. That is, the viewer cannot focus on the pixel if the viewer can only view the pixel with one eye but does not view this pixel with the other eye. Under the circumstance that the comparison area is not masked, the pixels A-D appear in the right eye frame RF but not in the left eye frame LF, so the viewer cannot focus on the pixels A-D. Thus, as the comparison area is masked in the present embodiment, preventing the viewer from viewing any spots on which the viewer cannot focus, hence improving the viewing comfort for the viewer.

Next, step 140 of FIG. 1, which corresponds to step 220 of FIG. 2A, is elaborated. In step 220, a first extension border area n1 further extends from the mask area LF_ML of the left eye frame LF and from the mask area RF_ML of the right eye frame RF. That is, the length of the mask area LF_ML of the left eye frame LF and the length of the mask area RF_ML of the right eye frame RF both include the length Lvf of the first extension border area n1. That is, in step 220, a length of Lvf pixels are further masked at the left border LB of the left eye frame LF, and a length of Lvf pixels are further masked at the left border LB of the right eye frame RF further. Exemplarily, in the present embodiment, the pixels E and F of the left eye frame LF and the pixels E and F of the right eye frame RF are masked.

After step 220, the length of the mask area LF_ML of the left eye frame LF is equal to Lvf, and the length of the mask area RF_ML of the right eye frame RF is equal to Lcom+Lvf. The principles of step 220 are that: when viewing the left eye frame LF and the right eye frame RF indicated in step 220 of FIG. 2A, the viewer would feel that the border and the image are on the same visual plane and can focus on the first extension border area n1.

Next, step 150 of FIG. 1, which corresponds to step 230 of FIG. 2A, is elaborated. In step 230, a second extension border area k1 further extends from the mask area LF_ML of the left eye frame LF, but the mask area RF_ML of the right eye frame RF does not extend the second extension border area k1. That is, in step 230, a length of Lfs pixels are further masked at the left border LB of the left eye frame LF. Thus, after step 230, the length of the mask area LF_ML of the left eye frame LF is equal to Lvf+Lfs, and the length of the mask area RF_ML of the right eye frame RF is equal to Lcom+Lvf.

In step 230, a virtual border formed by the mask area and the 3D image may be on different visual planes. That is, the viewer would view the virtual border as if he/she was viewing a photo frame. For example, the viewer would feel that the 3D image is indented into the virtual border, and would have more comfort in viewing a 3D image. If the mask area RF_ML of the right eye frame RF also includes the second extension border area k1, the virtual black border and the 3D image will be on the same visual plane, and the viewer's viewing comfort may not be improved. The length of the second extension border area k1 is equal to Lfs. It is noted that in other possible embodiments, the viewer may feel that the 3D image is projected from the virtual border, and such embodiments are still within the spirit of the disclosure.

Please refer to both FIG. 1 and FIG. 2B. Step 120 of FIG. 1 is elaborated. As indicated in FIG. 2B, since the left eye frame LF is shifted to the left by 4 pixels, four pixels (designated by Y1-Y4) at the right border RB of the left eye frame LF are removed and do not carry any meaning. On one hand, since the right eye frame RF is shifted to the right by 4 pixels, the originally 4 right-most pixels A1-D1 of the right eye frame RF are removed outside the visible area and become invisible.

The comparison between the left eye frame LF and the right eye frame RF shows that at the right border RB, the pixels A1, B1, C1, D1, Y1, Y2, Y3, Y4 appear in the left eye frame LF but not in the right eye frame RF. Thus, the area in which the pixels Y1, Y2, Y3, Y4, A1, B1, C1, and D1 are located is defined as a comparison area M2 whose length is twice as the shift distance.

Next, step 130 of FIG. 1, which corresponds to step 240 of FIG. 2B, is elaborated. In step 240, a mask area LF_MR is generated at the right border RB of the left eye frame LF, and a mask area RF_MR is generated at the right border RB of the right eye frame RF, according to the length of the comparison area M2. The mask area LF_MR includes a comparison area M2 whose length is also equal to Lcom. That is, in step 240, Lcom pixels are masked at the right border RB of the left eye frame LF, and no pixel is masked at the right border RB of the right eye frame RF.

Next, step 140 of FIG. 1, which corresponds to step 250 of FIG. 2B, is elaborated. In step 250, the first extension border area n2 further extends from the mask area LF_MR of the left eye frame LF and from the mask area RF_MR of the right eye frame RF. That is, the length of the mask area LF_MR of the left eye frame LF and the length of the mask area RF_MR of the right eye frame RF both further include the length Lvf of the first extension border area n2. The lengths of the first extension border areas n1 and n2 are both equal to Lvf.

That is, in step 250, a length of Lvf pixels are further masked at the right border RB of the left eye frame LF, and a length of Lvf pixels are masked at the right border RB of the right eye frame RF. Thus, after step 250 is performed, the length of the mask area LF_MR of the left eye frame LF is equal to Lcom+Lvf, and the length of the mask area RF_MR of the right eye frame RF is equal to Lvf. When watching the left eye frame LF and the right eye frame RF indicated in step 250 of FIG. 2B, the viewer would feel that the border and the image are on the same visual plane.

Next, step 150 of FIG. 1, which corresponds to step 260 of FIG. 2B, is elaborated. In step 260, a second extension border area k2 further extends from the mask area RF_MR of the right eye frame RF, but the mask area LF_MR of the left eye frame LF does not extend the second extension border area k2 (step 150), similar as in step 230 of FIG. 2A. The length of the second extension border area k2 is also equal to Lfs. That is, in step 260, a length of Lfs pixels are masked at the right border RB of the right eye frame LF. After step 260 is performed, the length of the mask area LF_MR of the left eye frame LF is equal to Lcom+Lvf, and the mask area RF_ML of the right eye frame RF is equal to Lvf+Lfs.

As indicated in FIG. 2A and FIG. 2B, for the left eye frame LF, the mask area LF_ML of the left border LB and the mask area LF_MR of the right border RB are asymmetric. Likewise, for the right eye frame RF, the mask area RF_ML of the left border LB and the mask area RF_MR of the right border RB are also asymmetric.

### Processing of Nearby Images:

Please refer to FIG. 3A and FIG. 3B. FIG. 3A shows image processing for the left border LB of the left eye frame and the left border LB of the right eye frame of a nearby 3D image according to the embodiment of the disclosure. FIG. 3B shows image processing for the right border RB of the left eye frame and the right border RB of the right eye frame of a nearby 3D image according to the embodiment of the disclosure. When watching a nearby 3D image as indicated in FIG. 3A and FIG. 3B, the viewer would feel that the 3D image is displayed close to the screen. That is, the viewer would feel that the 3D image is displayed at a location close to the front of the screen.

Please refer to both FIG. 1 and FIG. 3A. Firstly, step 120 of FIG. 1 is elaborated. As indicated in FIG. 3A, since the left eye frame LF′ is shifted to the right by 4 pixels, 4 pixels at the left border LB′ of the left eye frame LF′ are removed and become invisible (designated by X1′-X4′). On one hand, since the right eye frame RF′ is shifted to the left by 4 pixels, the originally 4 left-most pixels A′-D′ of the right eye frame LF′ are removed outside the visible area and become invisible.

The comparison between the left eye frame LF′ and the right eye frame RF′ shows that at the left border LB′, the pixel data X1′-X4′ and A′-D′ appear in the left eye frame LF′ but not in the right eye frame RF′. Thus, the area in which the pixel data X1′-X4′ and A′-D′ are located is defined as a comparison area M1′ whose length is twice as the shift distance.

Next, step 130 of FIG. 1, which corresponds to step 310 of FIG. 3A, is elaborated. In step 310, a mask area LF_ML′ is generated at the left border LB′ of the left eye frame LF′ and a mask area RF_ML′ is generated at the left border LB′ of the right eye frame RF′ according to the length of the comparison area M1′. In step 310, the length of the mask area RF_ML′ is temporarily equal to 0. In step 310, the mask area LF_ML′ includes a comparison area M1′; or, the length of the mask area LF_ML′ includes the length of the Lcom′ of the comparison area M1′. That is, in step 310, a length of Lcom′ pixels are masked at the left border LB′ of the left eye frame LF′, and no pixel is masked at the left border LB′ of the right eye frame RF′.

Next, step 140 of FIG. 1, which corresponds to step 320 of FIG. 3A, is elaborated. In step 320, the first extension border area n1′ further extends from the mask area LF_ML′ of the left eye frame LF′ and the mask area RF_ML′ of the right eye frame RF′ (step 140). The length of the mask area LF_ML′ of the left eye frame LF′ and the length of the mask area RF_ML′ of the right eye frame RF′ both include the length Lvf′ of the first extension border area n1′.

In step 320, a length of Lvf′ pixels are masked at the left border LB′ of the left eye frame LF′, and a length of Lvf′ pixels are masked at the left border LB′ of the right eye frame RF′. Thus, after step 320 is performed, the length of the mask area LF_ML′ of the left eye frame LF′ is equal to Lcom′+Lvf′, and the length of the mask area RF_ML′ of the right eye frame RF′ is equal to Lvf′. When watching the left eye frame LF′ and the right eye frame RF′ indicated in step 320 of FIG. 3A, the viewer would feel that the border and the image are on the same visual plane.

Next, step 150 of FIG. 1, which corresponds to step 330 of FIG. 3A, is elaborated. In step 330, the second extension border area k1′ further extends from the mask area LF_ML′ of the left eye frame LF′ but the mask area RF_ML′ of the right eye frame RF′ does not extend the second extension border area k1′ (step 150) similar as in step 230. That is, in step 330, a length of Lfs′ pixels are masked at the left border LB′ of the left eye frame LF′. Thus, after step 330 is performed, the length of the mask area LF_ML′ of the left eye frame LF′ is equal to Lcom′+Lvf′+Lfs′, and the mask area RF_ML′ of the right eye frame RF′ is equal to Lvf′.

Please refer to both FIG. 1 and FIG. 3B. Step 120 of FIG. 1 is elaborated. As indicated in FIG. 3B, since the right eye frame RF′ is shifted to the right by 4 pixels, four pixels (designated by Y1′-Y4′) at the right border RB′ of the right eye frame RF′ are removed. On one hand, since the left eye frame LF′ is shifted to the right by 4 pixels, the originally 4 right-most pixels A1′-D1′ of the left eye frame LF′ are removed outside the visible area and become invisible.

The comparison between the left eye frame LF′ and the right eye frame RF′ shows that in FIG. 3B, the pixel data Y1′-Y4′ and A1′-D1′ at the right border RB′ appear in the right eye frame RF′ but not in the left eye frame LF′. Thus, the location at which the pixel data Y1′-Y4′ and A1′-D1′ are located is defined as a comparison area M2′.

Next, step 130 of FIG. 1, which corresponds to step 340 of FIG. 3B, is elaborated. In step 340, a mask area LF_MR′ is generated at the right border RB′ of the left eye frame LF′ and a mask area RF_MR′ is generated at the right border RB′ of the right eye frame RF′ according to the length of the comparison area M2′. The mask area RF_MR′ includes the comparison area M2′ whose length is also equal to Lcom′. In step 340, the length of the mask area LF_ML′ is temporarily equal to 0. That is, in step 340, a length of Lcom′ pixels are masked at the right border RB′ of the right eye frame RF′, and no pixel is masked at the right border RB′ of the left eye frame LF′.

Next, step 140 of FIG. 1, which corresponds to step 350 of FIG. 3B, is elaborated. In step 350, the first extension border area n2′ further extends from the mask area LF_MR′ of the left eye frame LF′ and the mask area RF_MR′ of the right eye frame RF′. That is, the length of the mask area LF_MR′ of the left eye frame LF′ and the length of the mask area RF_MR′ of the right eye frame RF′ both include the length Lvf′ of the first extension border area n2′. The lengths of the first extension border areas n1′ and n2′ are both equal to Lvf′.

That is, in step 350, a length of Lvf′ pixels are masked at the right border RB′ of the left eye frame LF′, and a length of Lvf′ pixels are masked at the right border RB′ of the right eye frame RF′. Thus, after step 350 is performed, the length of the mask area LF_MR′ of the left eye frame LF′ is equal to Lvf′, and the length of the mask area RF_MR′ of the right eye frame RF′ is equal to Lcom′+Lvf′. When watching the left eye frame LF′ and the right eye frame RF′ indicated in step 350 of FIG. 3B, the viewer can feel that the border and image are on the same visual plane.

Next, step 150 of FIG. 1, which corresponds to step 360 of FIG. 3B, is elaborated. In step 360, the second extension border area k2′ further extends from the mask area RF_MR′ of the right eye frame RF′, but the mask area LF_MR′ of the left eye frame LF′ does not extend the second extension border area k2′ for reasons similar to those described in step 230 of FIG. 2A. The length of the second extension border area k2′ is also equal to Lfs′. That is, in step 360, Lfs′ pixels are masked at the right border RB′ of the right eye frame LF′. Thus, after step 360 is performed, the length of the mask area LF_MR′ of the left eye frame LF′ is equal to Lvf′, and the length of the mask area RF_ML′ of the right eye frame RF′ is equal to Lcom′+Lvf′+Lfs′.

As indicated in FIG. 3A and FIG. 3B, for the left eye frame LF′, the mask area LF_ML′ of the left border LB′ and the mask area LF_MR′ of the right border RB′ are asymmetric. Likewise, for the right eye frame RF′, the mask area RF_ML′ of the left border LB′ and the mask area RF_MR′ of the right border RB′ are also asymmetric.

In the above embodiments, if the mask area of the left border and the mask area of the right border of the lastly generated left eye frame have the first length and the second length respectively, and the mask area of the left border and the mask area of the right border of the lastly generated right eye frame have the third length and the fourth length respectively, then none of the first to the fourth lengths is equal to 0, the first length is not equal to the third length, and the second length is not equal to the fourth length. Furthermore, the first length and the fourth length are identical, and the second length and the third length are identical. In addition, the first length may be larger than the third length, and the fourth length may be larger than the second length.

In an example, the first length and the fourth length are both equal to Lcom+Lvf, and the second length and the third length are both equal to Lvf, wherein Lcom denotes the length of the comparison area including the pixel data appearing in only one of the first and the second eye frames. For example, the length is twice as the shift distance length of the original 2D image. The designation Lvf denotes a virtual border length, which may be designed according to actual needs.

In another example, the first length and the fourth length both are equal to Lcom+Lvf, the second length and the third length both are equal to Lvf+Lfs, wherein the designation Lcom denotes a comparison area length, which may be obtained from the above description. In addition, the designation Lvf denotes a virtual border length, and the designation Lfs denotes a border shift distance based on design needs.

In another example, the first length and the fourth length are both equal to Lcom+Lvf+Lfs, and the second length and the third length are both equal to Lvf. The designation Lcom denotes a comparison area length, the designation Lvf denotes a virtual border length, the designation Lfs denotes a border shift distance, and Lcom, Lvf, Lfs are respectively determined according to the above embodiments.

Moreover, in the present embodiment, for pixel rows of the 2D image, the shift distance and the length of the comparison area may be identical or different. Furthermore, for pixel rows of the 2D image, the shift distance and the length of the comparison area may vary with the row sequence of the pixel rows. For example, the pixel rows closer to the top end have a larger shift distance and a larger length of comparison area, and the pixel rows closer to the bottom have a smaller shift distance and a smaller length of comparison area, so as to improve the viewing comfort to the viewer when viewing 3D images.

In the above embodiments, since the virtual borders at the two sides of the left eye frame can be asymmetric, the original contents of the 2D image are visual as much as possible. In addition, in the above embodiments, the virtual borders may be implemented by black or white pixels (that is, the virtual border may be black or white), and are still within the spirit of the disclosure.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A three-dimension (3D) image processing method, comprising:
generating first and second eye frames of a 3D image from a frame of an original two-dimension (2D) image;
generating first and second mask areas at first and second boundaries of the first eye frame respectively; and
generating third and fourth mask areas at first and second boundaries of the second eye frame respectively;
wherein
a length of each of the first and the fourth mask areas comprises a length of a comparison area whose length is determined according to a pixel data difference obtained by comparing the first eye frame with the second eye frame; and
length of each of the first to the fourth mask areas further comprises a length of a first extension border area.

2. The 3D image processing method according to claim 1, wherein:
the comparison area of the first mask area comprises pixel data not appearing in the second eye frame based on comparison; and
the comparison area of the second mask area comprises pixel data not appearing in the first eye frame based on comparison.

3. The 3D image processing method according to claim 1, wherein the comparison area of the first mask area comprises pixel data at the first boundary of the first eye frame but not in the second eye frame, and the comparison area of the fourth mask area comprises pixel data at the second boundary of the second eye frame but not in the first eye frame.

4. The 3D image processing method according to claim 1, wherein the step of generating the first and the second eye frames of the 3D image from the frame of the original 2D image comprises:
shifting the frame of the original 2D image along two opposite directions by a shift distance for respectively generating the first and the second eye frames.

5. The 3D image processing method according to claim 4, wherein the length of the comparison area each of the first and the fourth mask areas is twice as the shift distance.

6. The 3D image processing method according to claim 1, wherein the length of the first extension border area of each of the first to the fourth mask areas is identical.

7. The 3D image processing method according to claim 1, wherein the length of each of the second and the third mask area further comprises a length of a second extension border area.

8. The 3D image processing method according to claim 7, wherein the length of the second extension border area of each of the second and the third mask area is identical.

9. A three-dimension (3D) image processing method, comprising:
generating first and second eye frames of a 3D image from a frame of an original two-dimension (2D) image;
generating first and second mask areas at first and second boundaries of the first eye frame respectively; and
generating third and fourth mask areas at first and second boundaries of the second eye frame respectively;
wherein
lengths of the first to the fourth mask areas respectively are first to the fourth lengths, none of the first to the fourth lengths is equal to 0, the first length is not equal to the third length, and the second length is not equal to the fourth length.

10. The 3D image processing method according to claim 9, wherein the first length is larger than the third length, and the fourth length is larger than the second length.

11. The 3D image processing method according to claim 9, wherein the first length and the fourth length are identical, and the second length and the third length are identical.

12. The 3D image processing method according to claim 9,
wherein the first length and the fourth length both are equal to Lcom+Lvf, and the second length and the third length both are equal to Lvf,
wherein Lcom denotes a comparison area length, and Lvf denotes a virtual border length.

13. The 3D image processing method according to claim 9, wherein
the first length and the fourth length both are equal to Lcom+Lvf, and the second length and the third length both are equal to Lvf+Lfs,
wherein Lcom denotes a comparison area length, Lvf denotes a virtual border length, and Lfs denotes a border shift distance length.

14. The 3D image processing method according to claim 9,
wherein the first length and the fourth length both are equal to Lcom+Lvf+Lfs, and the second length and the third length both are equal to Lvf,
wherein Lcom denotes a comparison area length, Lvf denotes a virtual border length, and Lfs denotes a border shift distance length.

15. The 3D image processing method according to claim 13, wherein the comparison area length is a length of a comparison area including pixel data appearing in only one of the first and the second eye frames based on comparison.

16. The 3D image processing method according to claim 15, wherein the comparison area length is twice a shift distance length of the first eye frame or the second eye frame with respect to the frame of the original 2D image.

17. The 3D image processing method according to claim 14, wherein the comparison area length is a length of a comparison area including pixel data appearing in only one of the first and the second eye frames based on comparison.

18. The 3D image processing method according to claim 17, wherein the comparison area length is twice a shift distance length of the first eye frame or the second eye frame with respect to the frame of the original 2D image.
